(19) United States
(12) Patent Application Publication
(10) Pub. No.: US 2025/0370251 A1
(43) Pub. Date: Dec. 4, 2025

(54) OPTICAL MECHANISM

(71) Applicant: Quanta Computer Inc., Taoyuan City (TW)

(72) Inventors: I-Hung CHIEN, Taoyuan City (TW); Chen-Yi LIN, Taoyuan City (TW); Yin-Ling CHANG, Taoyuan City (TW)

(21) Appl. No.: 19/218,942

(22) Filed: May 27, 2025

(30) Foreign Application Priority Data
Jun. 4, 2024 (TW) 113205799

(51) Int. Cl. G02B 27/00; G02B 7/02

(52) U.S. Cl. CPC G02B 27/0006; G02B 7/02

(57) ABSTRACT

An optical mechanism is provided, including a frame, a lens unit disposed in the frame, a circuit unit affixed to the frame, an optical sensor disposed on the circuit unit, and a heating unit. The heating unit has a heating portion and a conductive portion connected to each other, wherein the heating portion is embedded in the lens unit, and the conductive portion is electrically connected to the circuit unit and extends along a sidewall of the lens unit.

### CROSS REFERENCE TO RELATED APPLICATIONS

This Application claims priority of Taiwan Patent Application No. 113205799, filed Jun. 4, 2024, the entirety of which is incorporated by reference herein.

### BACKGROUND OF THE INVENTION

### Field of the Invention

The present invention relates to an optical mechanism, and, in particular, it relates to an optical mechanism having a heating unit.

### Description of the Related Art

With the progress of electronic technology and the gradual popularization of electric vehicles, advanced driver assistance systems (ADAS) have been widely used in various fields such as autonomous vehicles.

However, the camera modules used in these vehicles may be adversely affected by low temperatures, thus causing damage or functional failure of the optical mechanisms. Therefore, to design an optical mechanism for camera modules that can improve safety and reliability has become a challenge.

### BRIEF SUMMARY OF THE INVENTION

An embodiment of the present invention provides an optical mechanism that includes a frame, a lens unit disposed in the frame, a circuit unit affixed to the frame, an optical sensor disposed on the circuit unit, and a heating unit. The heating unit has a heating portion and a conductive portion connected to each other, wherein the heating portion is embedded in the lens unit, and the conductive portion is electrically connected to the circuit unit and extends along a sidewall of the lens unit.

In some embodiments, the frame includes a hollow structure and a base connected to each other, and the hollow structure is cylindrical and protrudes from the base to accommodate the lens unit.

In some embodiments, the conductive portion is situated between the sidewall of the lens unit and the hollow structure of the frame.

In some embodiments, the conductive portion is affixed to the circuit unit by laser welding.

In some embodiments, the optical mechanism further includes a bottom case surrounding the circuit unit, wherein the bottom case is affixed to the base of the frame by laser welding.

In some embodiments, the conductive portion extends through the frame and is electrically connected to the circuit unit.

In some embodiments, the optical mechanism further includes a pogo pin connector disposed at one end of the conductive portion and electrically connected to the circuit unit.

In some embodiments, the conductive portion extends through the circuit unit.

In some embodiments, the hollow structure forms a through hole, and the conductive portion extends through the through hole and electrically connects to the circuit unit.

In some embodiments, the lens unit includes an optical lens, and the heating portion has an annular structure surrounding the optical lens.

### BRIEF DESCRIPTION OF THE DRAWINGS

The present invention can be more fully understood by reading the subsequent detailed description and examples with references made to the accompanying drawings, wherein:

FIG. 1 is an exploded diagram of an optical mechanism 100 in accordance with an embodiment of the invention.

FIG. 2 is a perspective diagram of the optical mechanism 100 in FIG. 1 after assembly.

FIG. 3 is a side view of the lens unit L and the frame F of the optical mechanism 100 before assembly. FIG. 4 is a cross-sectional view of the heating unit H embedded in the lens unit L.

FIG. 5 is a schematic diagram showing that the hollow structure F1 of the frame F encompasses the conductive portion H2 of the heating unit H.

FIG. 6 is a partial enlarged diagram showing that the conductive portions H2 in FIG. 5 are connected to the circuit unit S through the conductive contacts P.

FIG. 7 is a schematic diagram showing that the solder G is applied to the corners of the circuit units S for affixing the circuit unit S to the lower side of the base F2 of the frame F.

FIG. 8 is a schematic diagram of the heating unit H and the frame F in accordance with another embodiment of the present invention.

FIG. 9 is a partial enlarged view showing the conductive portions H2 of the heating unit H extending through the circuit unit S, in accordance with another embodiment of the present invention.

### DETAILED DESCRIPTION OF THE INVENTION

The making and using of the embodiments of the optical mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

In the following detailed description of the preferred embodiments, reference is made to the accompanying drawings, and in which specific embodiments of which the invention may be practiced are shown by way of illustration. In this regard, directional terminology, such as “top,” “bottom,” “left,” “right,” “front,” “back,” etc., is used with reference to the orientation of the figures being described. The components of the present invention can be positioned in a number of different orientations. As such, the directional terminology is used for the purposes of illustration and is in no way limiting.

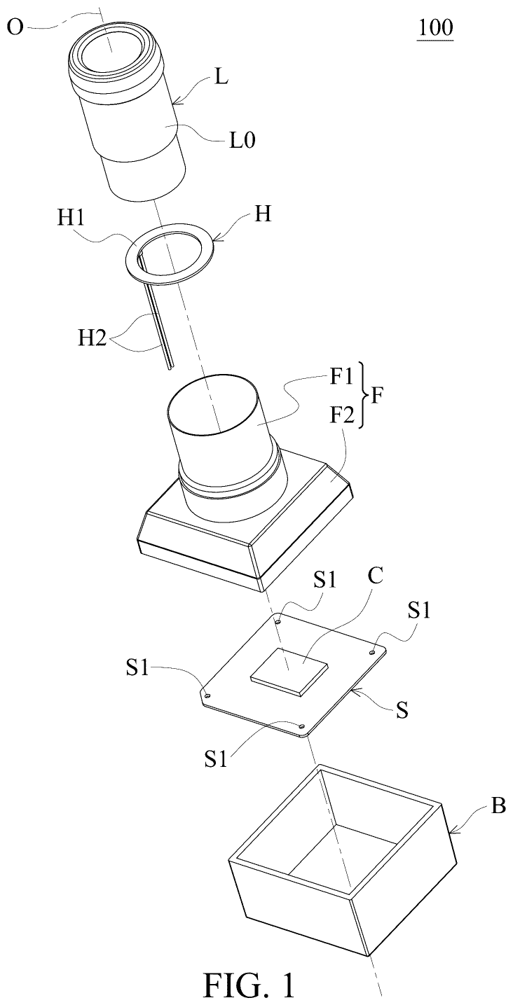

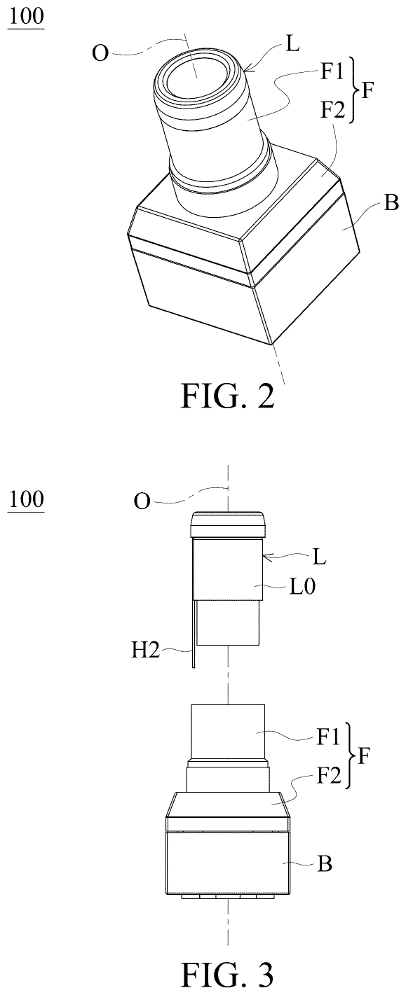

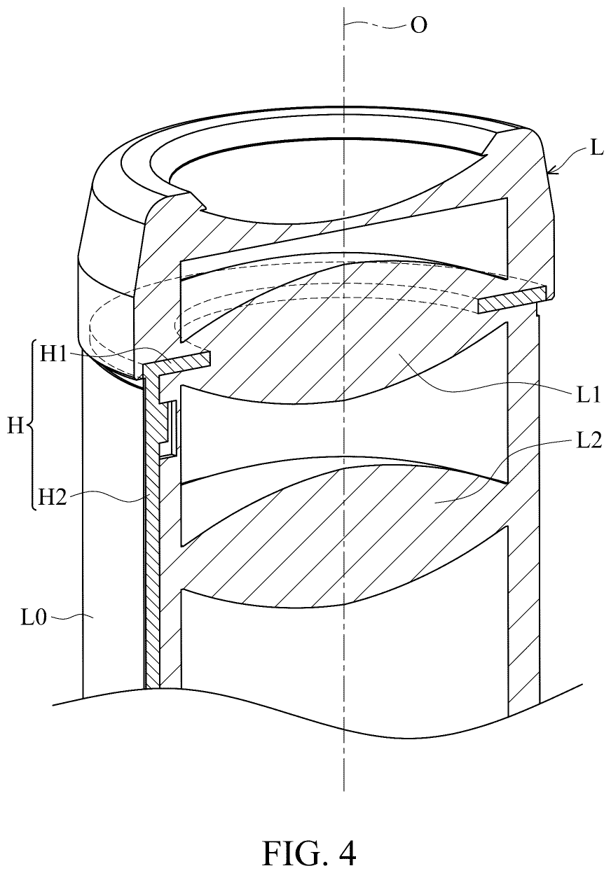

FIG. 1 is an exploded diagram of an optical mechanism 100 in accordance with an embodiment of the invention. FIG. 2 is a perspective diagram of the optical mechanism 100 in FIG. 1 after assembly. FIG. 3 is a side view of the lens unit L and the frame F of the optical mechanism 100 before assembly. FIG. 4 is a cross-sectional view of the heating unit H embedded in the lens unit L.

As shown in FIGS. 1, 2, 3, and 4, the optical mechanism 100 in this embodiment may comprise a camera module that is installed on a vehicle, which primarily includes a lens unit L, a heating unit H, a frame F, a circuit unit S, an optical sensor C, and a bottom case B. In this embodiment, the frame F includes a hollow structure F1 and a base F2 that are connected to each other. The hollow structure F1 is cylindrical and protrudes upward from the base F2 to accommodate the lens unit L. The optical sensor C is disposed on the circuit unit S. The circuit unit S and the bottom case B are affixed to the lower side of the frame F. The bottom case B surrounds and protects the circuit unit S after assembly.

For example, as shown in FIG. 1, the solder may be applied to the through holes S1 at the four corners of the circuit unit S, so that the circuit unit S can be affixed to the lower side of the base F2 of the frame F by soldering or laser welding. Additionally, the bottom case B may be affixed to the lower side of the base F2 of the frame F by laser welding to surround and protect the circuit unit S and the optical sensor C therein.

The optical sensor C may include an infrared or CCD image sensor, and the circuit unit S may include a printed circuit board. Light can enter the lens unit L along the optical axis O of the lens unit L. Subsequently, light L can propagate through the lens unit L and reach the optical sensor C on the circuit unit S to generate a digital image.

As can be seen in FIGS. 1, 3, and 4, the heating unit H includes an annular heating portion H1 and two longitudinal conductive portions H2, wherein the heating portion H1 is embedded in the lens unit L for heating the optical lens in the lens unit L. Therefore, the optical lens in the lens unit L can be operated within an appropriate temperature range without fogging. Moreover, the conductive portions H2 extend downward along the sidewall L0 of the lens unit L into the frame F (FIG. 3).

Referring to FIG. 4, an optical lens L1 and an optical lens L2 are provided inside the lens unit L, wherein the heating portion H1 of the heating unit H is embedded in the lens unit L and surrounds the optical lens L1. In this configuration, the optical lens L1 can be heated and maintained within an appropriate operating temperature range. Additionally, the conductive portions H2 of the heating unit H extend along the sidewall L0 of the lens unit L in the direction parallel to the optical axis O for electrically connecting to the circuit unit S.

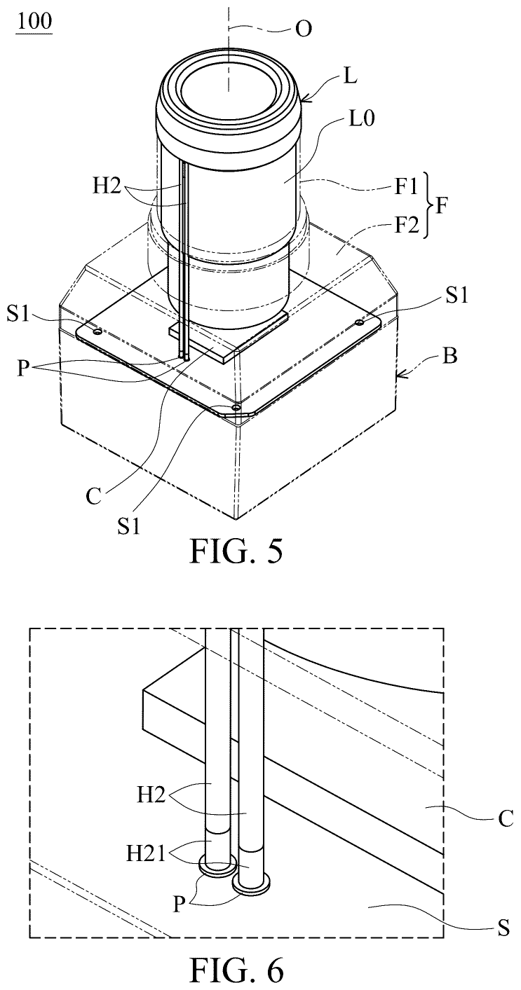

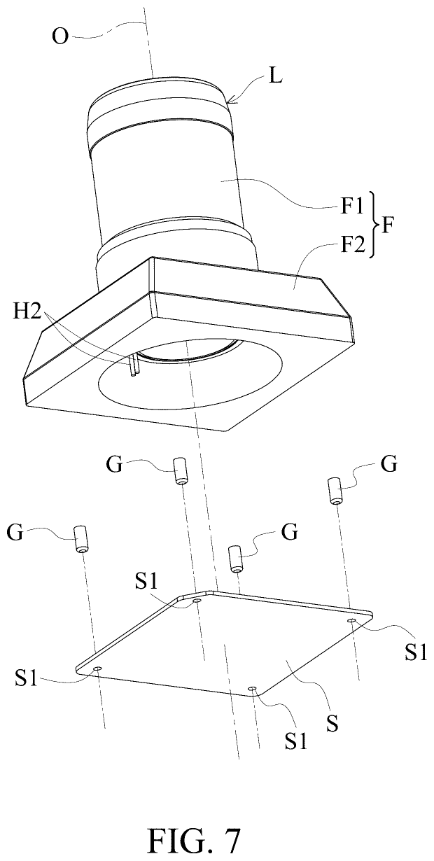

FIG. 5 is a schematic diagram showing that the hollow structure F1 of the frame F encompasses the conductive portion H2 of the heating unit H. FIG. 6 is a partial enlarged diagram showing that the conductive portions H2 in FIG. 5 are connected to the circuit unit S through the conductive contacts P. FIG. 7 is a schematic diagram showing that the solder G is applied to the corners of the circuit units S for affixing the circuit unit S to the lower side of the base F2 of the frame F.

As shown in FIGS. 5, 6, and 7, the conductive portions H2 of the heating unit H extend along the sidewall L0 of the lens unit L after assembly. Specifically, the conductive portions H2 pass through the hollow structure F1 and the base F2 of the frame F in sequence and connect to the circuit unit S located on the lower side of the frame F. It should be noted that the conductive portions H2 of the heating unit H are situated between the sidewall L0 of the lens unit L and the hollow structure F1 of the frame F after assembly. Moreover, since the conductive portions H2 are encompassed by the hollow structure F1 of the frame F and are not exposed to the outside, they can be prevented from short-circuiting or being damaged, thereby greatly improving the safety and reliability of the optical mechanism 100.

In this embodiment, two conductive contacts P are provided on the surface of the circuit unit S for electrically connecting the conductive portions H2 of the heating unit H to the circuit unit S. In some embodiments, the conductive contacts P may be metal pads (FIG. 6), and two pogo pin connectors H21 may be disposed at the ends of the conductive portions H2 of the heating unit H for electrically connecting to the conductive contacts P.

It can be seen in FIG. 7 that the solder G is disposed in the through holes S1 at the corners of the circuit unit S. During assembly of the optical mechanism 100, the circuit unit S can be affixed to the lower side of the base F2 of the frame F by soldering or laser welding. Moreover, the bottom case B can be affixed to the lower side of the base F2 of the frame F by laser welding, so as to surround and protect the circuit unit S and the optical sensor C therein.

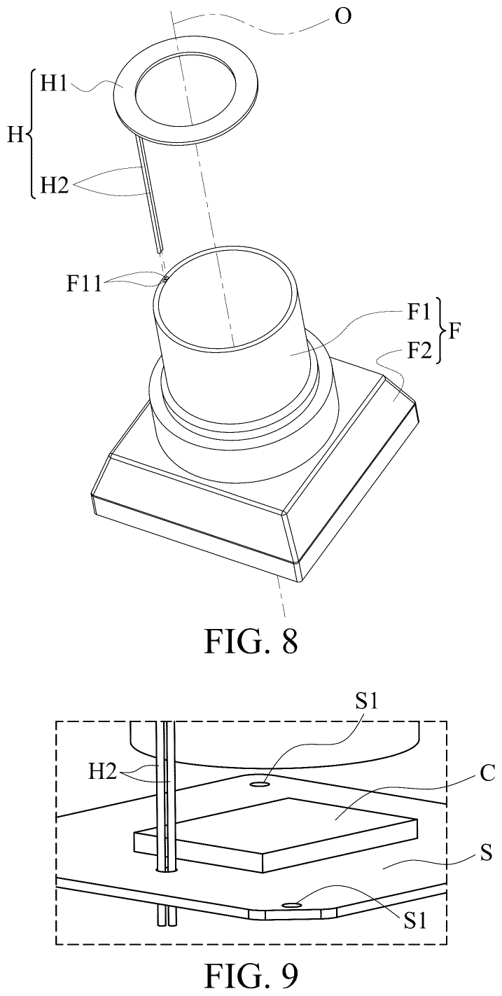

FIG. 8 is a schematic diagram of the heating unit H and the frame F in accordance with another embodiment of the present invention.

As shown in FIG. 8, the hollow structure F1 of the frame F in another embodiment forms two through holes F11 extending along the optical axis O for receiving the conductive portions H2 of the heating unit H. During assembly of the optical mechanism 100, the conductive portions H2 of the heating unit H can be inserted through the through holes F11 and connected to the circuit unit S that is located on the lower side of the base F2 of the frame F. In this configuration, the conductive portions H2 of the heating unit H can be encompassed and effectively protected by the frame F, and miniaturization of the optical mechanism 100 can also be achieved.

FIG. 9 is a partial enlarged view showing the conductive portions H2 of the heating unit H extending through the circuit unit S, in accordance with another embodiment of the present invention.

Referring to FIG. 9, in another embodiment of the optical mechanism 100, the conductive portions H2 of the heating unit H may extend through the circuit unit S. During assembly of the optical mechanism 100, the conductive portions H2 can be firmly affixed to the lower side of the circuit unit S by laser welding. Subsequently, the bottom case B can also be mounted to the lower side of the base F2 of the frame F by laser welding. However, the connection position of the conductive portions H2 and the circuit unit S is not limited to that disclosed in the embodiment of the present invention.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical mechanism, comprising:
a frame;
a lens unit, disposed in the frame;
a circuit unit, affixed to the frame;
an optical sensor, disposed on the circuit unit; and
a heating unit, having a heating portion and a conductive portion connected to each other, wherein the heating portion is embedded in the lens unit, and the conductive portion is electrically connected to the circuit unit and extends along a sidewall of the lens unit.

2. The optical mechanism as claimed in claim 1, wherein the frame includes a hollow structure and a base connected to each other, and the hollow structure is cylindrical and protrudes from the base to accommodate the lens unit.

3. The optical mechanism as claimed in claim 2, wherein the conductive portion is situated between the sidewall of the lens unit and the hollow structure of the frame.

4. The optical mechanism as claimed in claim 2, wherein the conductive portion is affixed to the circuit unit by laser welding.

5. The optical mechanism as claimed in claim 2, further comprising a bottom case surrounding the circuit unit, wherein the bottom case is affixed to the base of the frame by laser welding.

6. The optical mechanism as claimed in claim 2, wherein the conductive portion extends through the frame and is electrically connected to the circuit unit.

7. The optical mechanism as claimed in claim 2, further comprising a pogo pin connector disposed at an end of the conductive portion and electrically connected to the circuit unit.

8. The optical mechanism as claimed in claim 2, wherein the conductive portion extends through the circuit unit.

9. The optical mechanism as claimed in claim 2, wherein the hollow structure forms a through hole, and the conductive portion extends through the through hole and electrically connects to the circuit unit.

10. The optical mechanism as claimed in claim 1, wherein the lens unit includes an optical lens, and the heating portion has an annular structure surrounding the optical lens.
